(19) United States
(12) Patent Application Publication
(10) Pub. No.: US 2009/0176108 A1
(43) Pub. Date: Jul. 9, 2009

(54) TRANSPARENT MEMBER AND READING GLASS

(75) Inventors: Takahide Toyama, Tokyo (JP); Akihiro Nishida, Aichi (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/097,021

(22) PCT Filed: Dec. 5, 2006
(86) PCT No.: PCT/JP2006/324227

§ 371 Date: Jun. 11, 2008

(30) Foreign Application Priority Data
Dec. 16, 2005 (JP) 2005363034

(51) Int. Cl. B32B 17/06; B32B 27/06; G02B 1/10

(52) U.S. Cl. 428/429; 428/426; 359/507

(57) ABSTRACT

A transparent member whereupon a highly durable low-friction antifouling layer is formed, and a reading glass for a scanner are provided. The transparent member is characterized in that the low-friction antifouling film containing fluorine atoms is formed on the surface of a base material having a surface element composition containing an Fe of 0.1 atm % or less and an Sn of 3 atm % or less.

### TECHNICAL FIELD

The present invention relates to a transparent member for reading and a reading glass which are mounted on a PPC copying machine and a scanner and comprises a low friction antifouling layer with high durability.

### BACKGROUND ART

Generally, in a reading apparatus (scanner etc.) to read document sheets optically, a transparent member such as glass is used for the purpose of regulating and arranging a document sheet correctly at a focal position.

As a transparent member for reading a conveyed document sheet in an automatic document sheet conveyance type copying machine, a glass member provided with both high surface lubricity and low electrically charged ability has become adopted.

For example, when document sheets are automatically fed, poor feeding occurs due to static electricity and dust caused by friction. Therefore, there has been disclosed a technique to avoid adhesion of dust with low friction by forming a fluorine system low friction antifouling film on the surface of a reading glass.

However, in the case where the glass is rubbed repeatedly with paper, since there is a portion having a weak film strength under the influence of impurities on the surface of a base material on which a low friction antifouling film is formed, film peeling occurs by the repeated use. Therefore, a low friction antifouling film provided with resistance to wear has been requested.

When a float glass is used, for this request, there have been known the following techniques, such as a technique (for example, refer Patent document 1) to make the low friction antifouling film high durable by selecting a top surface containing a little amount of Sn (tin) and providing a fluoro alkyl group containing silane compound on the top surface, and a technique (for example, refer Patent document 2) to increase the bonding strength of the low friction antifouling film by increasing a silanol group with a surface treatment (acid treatment, polishing, plasma treatments under layer formation, and the like) on a glass base material and providing a fluoro alkyl group containing silane compound on it.

In such conventional techniques, in order to provide functions of slipping ability, water repellence, and antifouling property on the glass base material, one's attention has been especially paid to reduce a content of Sn as an impurity.

However, as a factor to inhibit the adhesion of the low friction antifouling film, inventors found out that there is another important factor in addition to a content of tin, and conceive the present invention.

Patent document 1: U.S. Pat. No. 3,130,244

Patent document 2: Japanese Patent Unexamined Publication No. 2004-67394

### DISCLOSURE OF THE INVENTION

### Problem to be Solved by the Invention

The present invention is made in view of the above-mentioned problem, and an object is to provide a transparent member in which a low friction antifouling layer with high durability is formed and a reading glass for a scanner.

### Means for Solving the Problem

The above object of the present invention above has been attained by the following constitutions.

1. A transparent member characterized in that on the surface of a base material in which an elemental composition of the surface contains iron atoms of 0.1 atomic percent or less and tin atoms of 3 atomic percent or less, is formed a low friction antifouling film containing fluorine atoms.
2. The transparent member described in the above-described 1 and characterized in that the low friction antifouling film is made of a fluoro alkyl group containing silane compound.
3. The transparent member described in the above-described 1 or 2 and characterized in that the surface of the base material is subjected to an activation treatment before being provided with the low friction antifouling film.
4. The transparent member described in the above-described 3 and characterized in that the activation treatment is at least one selected from a corona treatment, a plasma treatment, an atmospheric pressure plasma treatment, and a flame treatment.
5. The transparent member described in any one item of the above-described 1 to 4 and characterized in that the base material is a melted float glass and the low friction antifouling film is formed on the top surface of the melted float glass.
6. A reading glass characterized in that the surface of the transparent member described in any one item of the above-described 1 to 5 on which the low friction antifouling film is formed is a sheet passing surface.
7. The reading glass described in the above-described 6 and characterized in that an antistatic film is formed on a surface opposite to the surface on which the low friction antifouling film is formed.

### EFFECT OF THE INVENTION

According to the present invention, in a reading glass to read conveyed document sheets in an image forming apparatus such as a scanner and a copying machine, it is possible to avoid the deterioration of copy image quality due to streak noises caused by paper powder generated from document sheets, adhesive adhering on document sheets and adhesion of dust on the reading glass. As a result, as excellent feature, it is possible to provide a reading glass on which a low friction antifouling film with high durability capable of bearing passing-over by 200,000 sheets is formed. Further, with a technique to select a surface containing a little amount of iron, it is possible to increase a image reading power for an infrared region (high wavelength side).

### BRIEF DESCRIPTION OF THE DRAWINGS

FIG. 1 is a schematic diagram representing an example of two-step type atmospheric pressure plasma apparatus; and

FIG. 2 is a cross sectional schematic diagram representing an example of a copying apparatus.

FIG. 3 is an enlarged view in the vicinity of a reading glass in a conveyed sheet reading section.

### EXPLANATION OF REFERENCE SIGNS

3, 7 Rectangular electrode
4 Base material
8 Moving trestle electrode (first electrode)
9 Support base
10 Discharge gas
11 Thin film forming gas
12 Auxiliary gas
13 Discharge gas
14 Oxidizing gas
31, 33, 35 High frequency power source
100 Image forming apparatus
130, 131 Mirror unit
135 CCD
A Automatic document sheet conveyance means
B Reading means
C Image control means
D Image writing means
E Image forming means
F Sheet feeding means
G1 Reading glass
G2 Platen glass
H Fixing means

### BEST MODE FOR CARRYING OUT THE INVENTION

Hereafter, the present invention will be explained in detail.

In an image reading apparatus such as a scanner and a copying machine to read conveyed document sheets, dust, stain and agglutinative matters adhering on document sheets and paper powder generated at the time of conveying document sheets adhere on a reading glass and cause the deterioration of copy image quality. Then, in the present invention, a content of iron atoms in the surface of a transparent member is made less that a specified value and a low friction antifouling film is formed on the surface, whereby the low friction antifouling film with high durability can be obtained, and it becomes possible to provide a transparent member, in particular, a reading glass to prevent dust from adhering and to improve conveyance ability.

### <Base Material>

As the transparent member of the present invention, inorganic transparent base materials, such as glass base material, and organic transparent base materials such as plastic base material can be employed. Examples of the above-mentioned glass base material, include, for example, alkali containing glass substrate, such as a soda lime silicate glass substrate, and alkali-free glass substrate such as a borosilicate glass substrate.

Examples of resin base materials, include, for example, polyesters, such as polyethylene terephthalate and polyethylenenaphthalate; polyethylene; polypropylene; cellophane; cellulose esters or those derivatives, such as cellulose diacetate, cellulose triacetate, cellulose acetate butylate, cellulose acetate propionate, cellulose acetate phthalate and cellulose nitrate; polyvinylidene chloride, polyvinyl alcohol, polyethylene vinyl alcohol, syndiotactic polystyrene, polycarbonate, norbornene resin, polymethylpentene, polyether ketone, polyimide, polyether sulfone, polysulfones, polyether ketoneimide, polyamide, fluororesin, nylon, polymethylmethacrylate, an acrylic, polyarylates and organic-inorganic hybrid resin of these resins with silica and the like.

### <Low Friction Antifouling Film>

The low friction antifouling film containing fluorine atoms according to the present invention is preferably a thin film formed with an organometallic compound having an organic group containing fluorine atoms.

First, the organometallic compound having an organic group containing fluorine atoms preferably used in the present invention will be explained in detail.

In the organometallic compound having an organic group containing fluoride atoms according to the invention, examples of the organic group having a fluorine atom includes such as an alkyl group, an alkenyl group and an aryl group containing fluorine atoms, and organometallic compounds provided with an organic group having a fluoride atom utilized in the invention are those in which these organic groups having a fluorine atom are directly bonded to metals, for example, such as silicon, titanium, germanium, zirconium, tin, aluminum, indium, antimony, yttrium, lanthanum, iron, neodymium, copper, gallium and hafnium. Among these metals, preferable are silicon, titanium, germanium, zirconium and tin and more preferable are silicon and titanium. These organic groups having a fluorine atom may bonds to a metallic compound in any manner, for example, when a compound having a plural number of metallic atoms such as siloxane is provided with these organic groups, it is satisfactory that at least one metallic atom has an organic group having a fluorine atom regardless of the position.

According to a thin film forming method of employing the organometallic compound having an organic group containing fluoride atoms according to the invention, it is estimated that excellent effects of the invention are exhibited because an organometallic compound with an organic group containing a fluorine atom easily forms bonds with a substrate comprising such as silica and glass.

Organometallic compounds with an organic group containing a fluorine atom utilized in the invention are preferably compounds represented by aforesaid general formula (1).

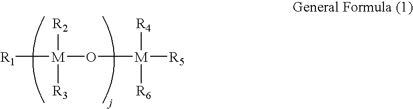

In aforesaid general formula (1), M represents Si, Ti, Ge, Zr or Sn. Further, R₁ to R₆ each represent a hydrogen atom or a monovalent group, and at least one of the groups represented by R₁ to R₆ is an organic group having a fluorine atom, for example, preferably an organic group containing an alkyl group, alkenyl group or aryl group having a fluorine atom. An alkyl group having a fluorine atom includes, for example, such as a trifluoromethyl group, a perfluoroethyl group, a perfluoropropyl group, a perfluorobutyl group and a 4,4,3,3,2,2,1,1-octafluorobutyl group, an alkenyl group having a fluorine atom includes, for example such as a 3,3,3-trifluoro-1-propenyl group, and an aryl group having a fluorine atom includes, for example, such as a pentafluorophenyl group. Further, also utilized can be such as an alkoxy group, an alkenyloxy group and an aryloxy group which are prepared from these alkyl groups, alkenyl groups or aryl groups having a fluorine atom.

Further, in such as the aforesaid alkyl group, alkenyl group and aryl group, any number of fluorine atoms may bond to any positions in their skeletons, however, it is preferable that at least one fluorine atom bonds to the groups. Further, carbon atoms in the skeletons of an alkyl group and an alkenyl group may be substituted, for example, by other atoms such as oxygen, nitrogen and sulfur, or bivalent groups containing such as oxygen, nitrogen and sulfur, for example, groups such as a carbonyl group and a thiocarbonyl group.

Among groups represented by R₁ to R₆ other than the aforesaid organic group having a fluorine atom represent a hydrogen atom or a monovalent group, which, for example, includes groups such as a hydroxyl group, an amino group, an isocyanate group, a halogen atom, an alkyl group, a cycloalkyl group, an alkenyl group, an alkoxy group, an alkenyloxy group and an aryloxy group, however, it is not limited thereto. j represents 0 or an integer of 1 to 150, preferably 0 to 50 and is more preferably in a range of 0 to 20.

Among aforesaid monovalent groups, a halogen atom is preferably a chlorine atom, a bromine atom or an iodine atom. Further, among an alkyl group, an alkenyl group, an aryl group, an alkoxy group, an alkenyloxy group and an aryloxy group as aforesaid monovalent groups, preferable are an alkoxy group, an alkenyloxy group and an aryloxy group.

Further, among metal atoms represented by M, Si and Ti are preferred.

The aforesaid monovalent groups may be further substituted by other groups, and preferable substituents, although not being specifically limited, include an amino group, a hydroxyl group, an isocyanate group, a halogen atom such as a fluorine atom, a chlorine atom and a bromine atom, an alkyl group, a cycloalkyl group, an alkenyl group, an aryl group such as a phenyl group, alkoxy group, an alkenyloxy group, an aryloxy group, an acyl group, an acyloxy group, an alkoxycarbonyl group, an alkaneamido group, an arylamido group, an alkylcarbamoyl group, an arylcarbamoyl group, a silyl group, an alkylsilyl group and an alkoxysilyl group.

Further, the aforesaid organic groups having a fluorine atom and other groups represented by these R₁ to R₆ may have a structure having a plural number of metal atoms further substituted by a group represented by R¹R²R³M- (M represents the aforesaid metal atom, R¹, R² and R³ each represent a monovalent group, and the monovalent group represents the aforesaid organic group having a fluorine atom or groups other than said organic group having a fluorine atom, which were listed as R₁ to R₆.). These metals include such as Si and Ti, and, for example, listed are such as a silyl group, an alkyl silyl group and an alkoxysilyl group.

An alkyl group and an alkenyl group as groups having a fluorine atom which were listed in aforesaid R₁ to R₆, in an alkyl group, an alkenyl group or an alkoxy group and an alkenyloxy group prepared from them, are preferably groups represented by following general formula (F).

Rf—X—(CH₂)ₖ— General Formula (F)

Herein, Rf represents an alkyl group or an alkenyl group in which at least one of hydrogen is replaced by a fluorine atom, and is preferably, for example, perfluoroalkyl groups such as a trifluoromethyl group, a pentafluoroethyl group, a perfluorooctyl group and a heptafluoropropyl group; such as a 3,3,3-trifluoropropyl group and a 4,4,3,3,2,2,1,1-octafluorobutyl group; or alkenyl groups substituted by a fluorine atom such as 1,1,1-trifluoro-2-chloropropenyl group. Among them, preferable are groups such as a trifluoromethyl group, a pentafluoroethyl group, a perfluorooctyl group and a heptafluoropropyl group, in addition to alkyl groups having two or more fluorine atoms such as a 3,3,3-trifluoropropyl group and a 4,4,3,3,2,2,1,1-octafluorobutyl group.

Further, X is a single bond or a bivalent group, and represents, as a bivalent group, groups such as —O—, —S— and —NR— (R represents a hydrogen atom or an alkyl group) and groups such as —CO—, —CO—O—, —CONH—, —SO₂NH—, —SO₂—O—, —OCONH—, and

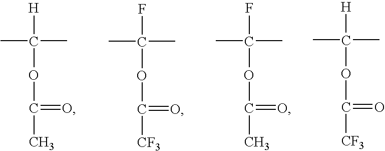

k represents 0 or an integer of 1 to 50 and preferably or an integer of 1 to 30.

Other substituents in addition to a fluorine atom may be substituted in Rf, and substitutable groups include those similar to groups listed as substituents in aforesaid R₁ to R₆. Further, skeleton carbon atoms in Rf may be partly substituted, for example, by groups such as —O—, —S—, —NR₀— (R₀ represents a hydrogen atom or a substituted or non-substituted alkyl group, and may be groups represented by aforesaid formula (F)), a carbonyl group, —NHCO—, —CO—O— and —SO₂NH—.

Among compounds represented by aforesaid general formula (1), preferable are compounds represented by following general formula (2).

[Rf—X—(CH₂)ₖ]_{q}-M(R₁₀)ᵣ(OR₁₁)ₜ General Formula (2)

In general formula (2), M represents a metal atom similar to that in the aforesaid general formula (1), and k represents also the same integer. R₁₀ represents an alkyl group or an alkenyl group, and R₁₁ represents an alkyl group, an alkenyl group or an aryl group; each may be substituted by similar groups listed as substituents of R₁ to R₆ in general formula (1), however, preferably represents a non-substituted alkyl group or alkenyl group. Further, q+r+t=4, q≧1 and t≧1. Further, two of R₁₀ may bond to form a ring when r≧2.

In general formula (2), furthermore preferable are compounds represented by following general formula (3).

Rf—X—(CH₂)ₖ-M(OR₁₂)₃ General Formula (3)

Herein, Rf, X and k have the same definitions as those in foregoing general formula (2). Further, R₁₂ has the same definition as R₁₂ in foregoing general formula (2). And M also has the same definition as M in foregoing general formula (2), however, specifically preferably is Si or Ti and most preferably Si.

In the invention, other preferable examples of organometallic compounds having a fluorine atom include compounds represented by foregoing general formula (4).

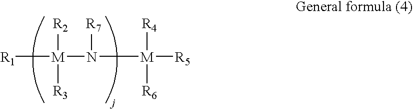

R₁ to R₆ in foregoing general formula (4) have the same definitions as R₁ to R₆ in foregoing general formula (1) Herein, also at least one of R₁ to R₆ is the foregoing organic group having a fluorine atom and preferably groups represented by foregoing general formula (F). R₇ represents a hydrogen atom, or a substituted or non-substituted alkyl group. Further, j represents 0 or an integer of 1 to 100, preferably 0 to 50 and j is most preferably in a range of 0 to 20.

Other preferable compounds having a fluorine atom in the invention include organometallic compounds having a fluorine atom represented by following general formula (5).

[Rf—X—(CH₂)ₖ—Y]ₘ-M(R₈)ₙ(OR₉)ₚ General Formula (5)

In general formula (5), M represents In, Al, Sb, Y or La. Rf and X represent groups similar to Rf and X in foregoing general formula (F). Y represents a single bond or oxygen. k similarly also represents 0 or an integer of 1 to 50 and preferably 0 or an integer of 1 to 30. R₉ represents an alkyl group or an alkenyl group, and R₈ represents an alkyl group, an alkenyl group or an aryl group; each may be substituted by similar groups listed as substituents of R₁-R₆ in general formula (1). Further, in general formula (5), m+n+p=3, m being at least 1, and n represents 0 to 2 and p also represents 0 to 2. It is preferable that m+n=3, that is, n=0.

Other preferable compounds having a fluorine atom in the invention include organometallic compounds having a fluorine atom represented by following general formula (6).

R^{f1}(OC₃F₆)ₘ₁—O—(CF₂)ₙ₁—(CH₂)ₚ₁-Z-(CH₂)_{q1}—Si—(R²)₃ General Formula (6)

In general formula (6), R^{f1} represents a straight chain or blanched chain perfluoroalkyl group having a carbon number of 1 to 16, R² represents a hydrolysable group and Z represents —OCONH— or —O—; m1 represents 0 or an integer of 1 to 50, n1 represents 0 or an integer of 1 to 3, p1 represents 0 or an integer of 1 to 3, q1 represents an integer of 1 to 6, and 6≧n1+p1>0.

The carbon number of a straight chain or branched chain perfluoroalkyl group which can be introduced into R^{f1} is more preferably 1 to 16, and most preferably 1 to 3. Therefore, R^{f1} is preferably such as —CF3, —C₂F₅ and —C₃F₇.

Hydrolysable groups which can be introduced in R² are preferably such as —Cl, —Br, —I, —OR¹¹, —OCOR¹¹, —CO(R¹¹)C═C(R¹²)₂, —ON═C(R¹¹)₂, —ON═CR¹³, —N(R¹²)₂ and R¹²NOCR¹¹. R¹¹ represents an aliphatic hydrocarbon group having a carbon number of 1 to 10 such as an alkyl group, or an aromatic hydrocarbon group having a carbon number of 6 to 20 such as a phenyl group, R¹² represents a hydrogen atom or an aliphatic hydrocarbon group having a carbon number of 1 to 5 such as an alkyl group, and R¹³ represents a bivalent aliphatic hydrocarbon group having a carbon number of 3 to 6 such as an alkylidene group. Among these hydrolysable groups, preferable are —OCH₃, —OC₂Hs, —OC₃H₇, —OCOCH₃ and —NH₂.

m1 in foregoing general formula (6) is more preferably 1 to 30 and furthermore preferably 5 to 20. n1 is more preferably 1 or 2, and p1 is more preferably 1 or 2. Further, q1 is more preferably 1 to 3.

Other preferable compounds having a fluorine atom in the invention include organometallic compounds having a fluorine atom represented by foregoing general formula (7).

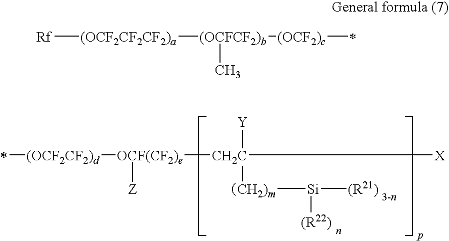

In foregoing general formula (7), Rf represents a straight chain or branched chain perfluoroalkyl group having a carbon number of 1 to 16, X represents a iodine atom or a hydrogen atom, Y represents a hydrogen atom or a lower alkyl group, Z represents a fluorine atom or a trifluoromethyl group, R²¹ represents a group being hydrolyzable, R²² represents a hydrogen atom or an inert monovalent group, and a, b, c and d each represent 0 or an integer of 1 to 200, e represents 0 or 1, m represents 0 or an integer of 1 to 2 and p represents an integer of 1 to 10.

In foregoing general formula (7), Rf represents a straight chain or branched chain perfluoroalkyl group having a carbon number of 1 to 16, and preferably is a CF₃, C₂F₅ or C₂F₅ group. Lower alkyl groups of Y generally include those having a carbon number of 1 to 5.

A hydrolysable group of R²¹ is preferably a halogen atom such as a chlorine atom, a bromine atom and an iodine atom, R²³O group, R²³COO group, (R²⁴)₂C═C(R²³)CO group, (R²³)₂C═NO group, (R²⁴)₂N group or R²³CONR²⁴ group. Herein, R²³ is an aliphatic hydrocarbon group having generally a carbon number of 1 to 10 such as an alkyl group or an aromatic hydrocarbon having generally a carbon number of 6 to 20, R²⁴ is a hydrogen atom or a lower aliphatic hydrocarbon group having generally a carbon number of 1 to 5 such as an alkyl group, and R²⁵ is a bivalent aliphatic hydrocarbon group having generally a carbon number of 3 to 6 such as an alkylidene group, and furthermore preferably a chlorine atom, CH₃O group, C₂H₅O group or C₃H₇O group.

R²² is a hydrogen atom or an inert monovalent organic group and preferably a hydrocarbon group having generally a carbon number of 1 to 4 such as an alkyl group. a, b, c and d are 0 or an integer of 1 to 200 and preferably 1 to 50. m and n are 0 or an integer of 1 to 2 and preferably 0. p is an integer of not less than 1, preferably 1 to 10 and more preferably an integer of 1 to 5. Further, an average molecular weight is 5×10² to 1×10⁵ and preferably 1×10³ to 1×10⁴.

Further, a preferable structure of silane compounds represented by aforesaid general formula (7) are those in which Rf is C₃F₇ group, a is integers of 1 to 50, b, c and d are 0; e is 1, Z is a fluorine atom and n is 0.

In the invention, listed below are organometallic compounds with an organic group containing a fluorine atom which are preferably utilized as a silane compound having a fluorine atom and typical examples of compounds represented by aforesaid general formula (1) to (7), however, the invention is not limited to these compounds.

### 1: (CF₃CH₂CH₂)₄Si

### 2: (CF₃CH₂CH₂)₂(CH₃)₂Si

### 3: (C₈F₁₇CH₂CH₂)Si(OC₂H₅)₃

### 4: CH₂═CH₂Si(CF₃)₃

### 5: (CH₂═CH₂COO)Si(CF₃)₃

### 6: (CF₃CH₂CH₂)₂SiCl(CH₃)

### 7: C₈F₁₇CH₂CH₂Si(Cl)₃

### 8: (C₈F₁₇CH₂CH₂)₂Si(OC₂H₅)₂

### 9: CF₃CH₂CH₂Si(OCH₃)₃

### 10: CF₃CH₂CH₂SiCl₃

### 11: CF₃(CF₂)₃CH₂CH₂SiCl₃

### 12: CF₃(CF₂)₅CH₂CH₂SiCl₃

### 13: CF₃(CF₂)₅CH₂CH₂Si(OCH₃)₃

### 14: CF₃(CF₂)₇CH₂CH₂SiCl₃

### 15: CF₃(CF₂)₇CH₂CH₂Si(OCH₃)₃

### 16: CF₃(CF₂)₈CH₂Si(OC₂H₅)₃

### 17: CF₃(CH₂)₂Si(OC₂H₅)₃

### 18: CF₃(CH₂)₂Si(OC₃H₇)₃

### 19: CF₃(CH₂)₂Si(OC₄H₉)₃

### 20: CF₃(CF₂)₅(CH₂)₂Si(OC₂H₅)₃

### 21: CF₃(CF₂)₅(CH₂)₂Si(OC₃H₇)₃

### 22: CF₃(CF₂)₇(CH₂)₂Si(OC₂H₅)₃

### 23: CF₃(CF₂)₇(CH₂)₂Si(OC₃H₇)₃

### 24: CF₃(CF₂)₇(CH₂)₂Si (OCH₃)(OC₃H₇)₂

### 25: CF₃(CF₂)₇(CH₂)₂Si(OCH₃)₂OC₃H₇

### 26: CF₃(CF₂)₇(CH₂)₂SiCH₃(OCH₃)₂

### 27: CF₃(CF₂)₇(CH₂)₂SiCH₃(OC₂H₅)₂

### 28: CF₃(CF₂)₇(CH₂)₂SiCH₃(OC₃H₇)₂

### 29: (CF₃)₂CF(CF₂)₈(CH₂)₂Si(OCH₃)₃

### 30: C₇F₁₅CONH(CH₂)₃Si(OC₂H₅)₃

### 31: C₈F₁₇SO₂NH(CH₂)₃Si(OC₂H₅)₃

### 32: C₈F₁₇(CH₂)₂OCONH(CH₂)₃Si(OCH₃)₃

### 33: CF₃(CF₂)₇(CH₂)₂Si (CH₃)(OCH₃)₂

### 34: CF₃(CF₂)₇(CH₂)₂Si(CH₃)(OC₂H₅)₂

### 35: CF₃(CF₂)₇(CH₂)₂Si (CH₃)(OC₃H₇)₂

### 36: CF₃(CF₂)₇(CH₂)₂Si (C₂H₅)(OCH₃)₂

### 37: CF₃(CF₂)₇(CH₂)₂Si (C₂H₅)(OC₃H₇)₂

### 38: CF₃(CH₂)₂Si(CH₃)(OCH₃)₂

### 39: CF₃(CH₂)₂Si(CH₃)(OC₂H₅)₂

### 40: CF₃(CH₂)₂Si (CH₃)(OC₃H₇)₂

### 41: CF₃(CF₂)₅(CH₂)₂Si(CH₃)(OCH₃)₂

### 42: CF₃(CF₂)₅(CH₂)₂Si(CH₃)(OC₃H₇)₂

### 43: CF₃(CF₂)₂O(CF₂)₃(CH₂)₂Si(OC₃H₇)₃

### 44: C₇F₁₅CH₂O(CH₂)₃Si(OC₂H₅)₃

### 45: C₈F₁₇SO₂O(CH₂)₃Si(OC₂H₅)₃

### 46: C₈F₁₇(CH₂)₂OCHO(CH₂)₃Si(OCH₃)₃

### 47: CF₃(CF₂)₅CH(C₄H₉)CH₂Si(OCH₃)₃

### 48: CF₃(CF₂)₃CH(C₄H₉)CH₂Si(OCH₃)₃

49: (CF₃)₂(p-CH₃—C₆H₅)COCH₂CH₂CH₂Si(OCH₃)₃

### 50: CF₃CO—O—OCH₂CH₂CH₂Si(OCH₃)₃

### 51: CF₃(CF₂)₃CH₂CH₂Si (CH₃)Cl

### 52: CO₃CH₂CH₂(CH₃)Si(OCH₃)₂

### 53: CF₃CO—O—Si(CH₃)₃

### 54: CF₃CH₂CH₂Si (CH₃)Cl₂

55: (CF₃)₂(p-CH₃—C₆H₅)COCH₂CH₂Si(OCH₃)₃
56: (CF₃)₂(p-CH₃—C₆H₅)COCH₂CH₂Si(OC₅H₅)₃

### 57: (CF₃C₂H₄)(CH₃)₂Si—O—Si(CH₃)₃

### 58: (CF₃C₂H₄)(CH₃)₂Si—O—Si(CF₃C₂H₄)(CH₃)₂

### 59: CF₃(OC₃F₆)₂₄—O—(CF₂)₂—CH₂—O—CH₂Si(OC₃)₃

60: CF₃O(CF(CF₃)CF₂O)ₘCF₂CONHC₃H₅Si(OC₂H₅)₃ (m=11-30)
61 (C₂H₅O)₃SiC₃H₆NHCOCF₂O(CF₂O)ₙ(CF₂CF₂O)ₚCF₂CONHC₃H₆Si(OC₂H₅)₃ (n/p is approximately 0.5, number average molecular weight is approximately 3000)
62: C₃F₇—(OCF₂CF₂CF₂)_{q}—O—(CF₂)₂—[CH₂CH{Si—(OCH₃)₃}]₉—H (q is approximately 10)
63: F(CF(CF₃) CF₂O)₁₅CF(CF₃)CONHCH₂CH₂CH₂Si(OC₂H₅)₂

### 64: F(CF₂)₄[CH₂CH(Si(OCH₃)₃)]_{2.02}OCH₃

65: (C₂H₅O)₃SiC₃H₆NHCO—[CF₂(OC₂F₄)₂₀(OCF₂)₆OCF₂]-CONHC₃H₆Si(OC₂H₅)₃

### 66: C₃F₇(OC₂F₆)₂₄O(CF₂)₂CH₂OCH₂Si(OCH₃)₃

### 67: CF₃(CF₂)₃(C₆H)C₂H₄Si(OCH₃)₃

### 68: (CF₃)₂CF (CF₂)₆CH₂CH₂SiCH₃(OCH₃)₂

### 69: CF₃(CF₂)₃(C₁H₄)C₂H₄SiCH₃(OCH₃)₂

### 70: CF₃(CF₂)₅(C₆H₄)C₂H₄Si(OC₂H₅)₃

### 71: CF₃(CF₂)₃C₂H₄Si(NCO)₃

### 72: CF₃(CF₂)₅C₂H₄Si(NCO)₃

### 73: C₉F₁₉CONH(C₁H₂)₃Si(OC₂H₁₅)₃

### 74: C₉F₁₉CONH(CH₂)₃SiCl₃

### 75: C₉F₁₉CONH(CH₂)₃Si(OC₂H₅)₃

76: C₃F₇O(CF(CF₃)CF₂O)₂—CF(CF₃)—CONH(CH₂)Si(OC₂H₅)₃
77: CF₃O(CF(CF₃)CF₂O)₆CF₂CONH(CH₂)₃SiOSi(OC₂H₅)₂(CH₂)₃NHCOCF₂(OCF₂CF(CF₃))₆OCF₃

### 78: C₃F₇COOCH₂Si(CH₃)₂OSi(CH₃)₂CH₂OCOC₃F₇

79: CF₃(CF₂)₇CH₂CH₂O(CH₂)₃Si(CH₃)₂OSi(CH₃)₂(CH₂)₃OCH₂CH₂(CF₂)₇CF₃
80: CF₃(CF₂)₅CH₂CH₂O(CH₂)₂Si(CH₃)₂Si(CH₃)₂(OC₂H₅)
81: CF₃(CF₂)₅CH₂CH₂O(CH₂)₂Si (CH₃)₂OSi(CH₃)(OC₂H₅)₂
82: CF₃(CF₂)₅CH₂CH₂O(CH₂)₂Si(CH₃)₂OSi(CH₃)₂OSi(CH₃)₂(OC₂H₅)

As other than the compounds exemplified above, listed are fluorine substituted alkoxysilane such as;

83: (perfluoropropyloxy)dimethylsilane
84: tris(perfluoropropyloxy)methylsilane
85: dimethylbis(nonafluorobutoxy)silane
86: methyltris(nonafluorobutoxy)silane
87: bis(perfluoropropyloxy)diphenylsilane
88: bis(perfluoropropyloxy)methylvinylsilane
89: bis(1,1,1,3,3,4,4,4-octafluorobutoxy)dimethysilane
90: bis(1,1,1,3,3,3-hexafluoroisopropoxy)dimethysilane
91: tris(1,1,1,3,3,3-hexafluoroisopropoxy)methysilane
92: tetrakis(1,1,1,3,3,3-hexafluoroisopropoxy)silane
93: dimethylbis(nonafluoro-t-butoxy)silane
94: bis(1,1,1,3,3,3-hexafluoroisopropoxy)diphenylsilane
95: tetrakis(1,1,3,3-tetrafluoroisopropoxy)silane
96: bis[1,1-bis(trifluoromethyl)ethoxy]dimethylsilane
97: bis(1,1,1,3,3,4,4,4-octafluoro-2-butoxy)dimethylsilane
98: methyltris[2,2,3,3,3-pentafluoro-1,1-bis(trifluoromethyl)propoxy]silane
99: diphenylbis[2,2,2-trifluoro-1-(trifluoromethyl)-1-tolylethoxylsilane

In addition to the following compounds;

### 100: (CF₃CH₂)₃Si (CH₂—NH₂)

### 101: (CF₃CH₂)₃Si—N(CH₃)₂

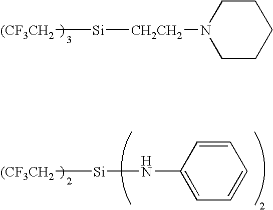

Further, silazane series such as;

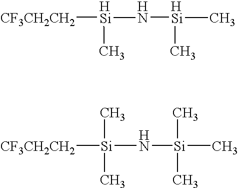

Organotitanium compound provided with fluorine such as;

### 106: CF₃CH₂—CH₂TiCl₃

### 107: CF₃(CF₂)₃CH₂CH₂TiCl₃

### 108: CF₃(CF₂)₅CH₂CH₂Ti(OCH₃)₃

### 109: CF₃(CF₂)₇CH₅CH₂TiCl₃

### 110: Ti(OC₅F₇)₄

### 111: (CF₃CH₂—CH₂O)₂TiCl₃

### 112: (CF₃C₂H₄)(CH₃)₂Ti—O—Ti(CH₃)₃

and can be listed are the following fluorine containing organometallic compounds.

### 113: CF₃(CF₂)₃CH₂CH₂—O—(CH₂)₃GeCl

### 114: CF₃(CF₂)₃CH₂CH₂OCH₂Ge(OCH₃)₃

### 115: (C₃F₇O)₂Ge(OCH₃)₂

### 116: [(CF₃)₂CHO]₄Ge

### 117: [(CF₃)₂CHO]₄Zr

### 118: (C₃F₇CH₂CH₂)₂Sn(OC₂H₅)₂

### 119: (C₃F₇CH₂CH₂)Sn(OC₂H₅)₃

### 120: Sn(OC₃F₇)₄

### 121: CF₃CH₂CH₂In(OCH₃)₂

### 122: In(OCH₂CH₂OC₃F₇)₃

### 123: Al(OCH₂CH₂OC₃F₇)₃

### 124: Al(OC₃F₇)₃

### 125: Sb(OC₃F₇)₃

### 126: Fe(OC₃F₇)₃

### 127: Cu(OCH₂CH₂OC₃F₇)₂

### 128: C₃F₇(OC₃F₆)₂₄O(CF₂)₂CH₂OCH₂Si(OCH₃)₃

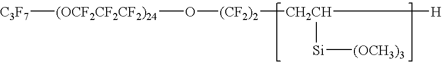

Each compound listed as a specific example is easily available on the market from such as Dow Corning-Toray Silicone Co., Ltd., Shin-Etsu Chemical Co., Ltd., Daikin Chemicals Co., Ltd. (for example Optool DSX) and Gelest Inc.; in addition, it can be prepared according to a synthesizing method or one in accordance therewith, for example, described in such as J. Fluorine Chem., 79(1), 87 (1996); Zairyo Gijutsu, 16(5), 209 (1998); Collect. Czech. Chem. Commun., Vol. 44, pp. 750-755; J. Amer. Chem. Soc. Vol. 112, pp. 2341-2348 (1990); Inorg. Chem., Vol. 10, pp. 889-892 (1971); U.S. Pat. No. 3,668,233; or JP-A Nos. 58-122979, 7-242675, 9-61605, 11-29585, 2000-64348 and 2000-144097.

In the present invention, the thin film is formed on a base material by use of the organometallic compound having an organic group containing these fluorine atoms. The use of raw material containing these organometallic compounds as a principal component means that these components are contained in amount of 50% by weight or more in the raw material used for film formation, and more preferably these components are contained in amount of 70% by weight or more.

There is no particular restriction to a method of coating the fluorine atom containing low friction antifouling film on the surface of a transparent base material by use of an organometallic compound having an organic group containing these fluorine atoms, examples of the method include a spin coating method, dip coating method, extrusion coating method, roll coating/spray coating method, gravure coating method, wire bar method, and air knife method. The dip coating method is simple and preferably used, wherein the organometallic compound having an organic group containing fluorine atoms is diluted with a solvent, and a glass base material is dipped and coated in the solvent.

In the present invention, the fluorine atom containing low friction antifouling film is coated directly, not through any other layer interposed, on at least one surface of the base material. Further, the fluorine containing film can be coated on both sides of the base material. Use of the aforementioned dip coating method permits both sides to be coated simultaneously, and hence, this procedure is preferably used.

In the present invention, before the fluorine containing film is formed on one side of the transparent base material, the surface of the aforementioned transparent base material is preferably provided with at least one of activation processing steps selected from among a corona treatment, plasma treatment, atmospheric pressure plasma treatment, and flame treatment. Use of the atmospheric pressure plasma treatment (to be described later) or the corona discharge treatment in particular permits formation of a fluorine containing film characterized by excellent durability, and hence this procedure is preferably used.

In the present invention, when the transparent member is used as a reading glass, before the low friction antifouling film is coated, it is desirable that an antistatic transparent conductive film is formed on the surface opposite to the surface (hereafter, referred to “sheet passing surface”) coming in contact with the document sheet, and thereafter, the low friction antifouling film is formed on both sides of transparent member by the dip coating method. Even if the transparent conductive film is formed on the surface opposite to the sheet passing surface, the transparent member has a surface charging suppressing effect (antistatic effect) by a rear surface electrode effect.

To be more specific, when the surface is charged, the electric line of force rises perpendicularly to the surface (toward the ground). If a conductive layer is located on the rear surface, the electrostatic charge on the front surface is lost when the electric line of force faces the rear surface (disappears below). This arrangement suppresses electric suction of dust and others.

This antistatic transparent conductive film is preferably connected to the ground. Indium oxide, tin doped indium oxide (ITO) or tin oxide film is preferably used as the transparent conductive film. The area resistivity is preferably 10⁹ ohms/square or less, more preferably 10⁶ ohms/square or less. These films are preferably coated, for example, according to vacuum vapor deposition method, sputtering method, or CVD method.

In the conventional art, since the aforementioned transparent conductive film is soft, if a low friction film is formed on the transparent conductive film, the low friction film may be separated together with the transparent conductive film. In the preferred embodiment of the present invention, a transparent conductive film of low film surface strength is formed on the rear surface of the glass base material (the surface opposite to the sheet passing surface), and the low friction antifouling film of the present invention is coated on the sheet passing surface of the glass base material (surface coming in contact with the document sheet). This arrangement provides a reading glass excelling in low friction, strong film strength, antifouling property, good conveying performance and high durability, without attracting toner and paper powder at a low electrostatic charge.

Before the low friction antifouling film and the transparent conductive film are formed on the surface of the transparent base material, it is desirable to perform at least one activating treatment selected from a corona treatment, a plasma treatment, an atmospheric pressure plasma treatment, and a flame treatment on the surface of the base material. Especially, when the atmospheric pressure plasma treatment mentioned later or the corona discharging treatment is performed, it is possible to obtain the effect to enhance remarkably the durability of the fluorine atom containing film.

<<Measurement by XPS>>

The element composition (atomic ratio) in the present invention can be measured by the XPS surface analysis apparatus. Any type of the XPS surface analysis apparatus can be used. In the example of the present invention, Model ESCALAB-200R, a product by VG Scientific Co., Ltd. was used. To measure the surface layer of the fluorine containing film, the angle (take-off angle) formed by the sample and detector was measured at an angle of 30°, a spot diameter was 1 mm and a detecting depth was several nm on the upper most surface.

In order to make an amount of tin (Sn) on the surface of a base material to be 0.1 to 3 atm %, in the glass formed by the melting float process, it is possible to make it within a target range usually by selecting a top surface. However, it is also possible to decrease the concentration of tin in the surface by conducting the above surface activating treatment for relatively long period.

<<Atmospheric Pressure Plasma Method>>

In the reading glass of the present invention, the atmospheric pressure plasma method is preferably used at the time of activating the front surface of the glass base material and forming a transparent conductive film on the rear surface of the glass material. Referring to drawings, the following describes the atmospheric pressure plasma method of the present invention.

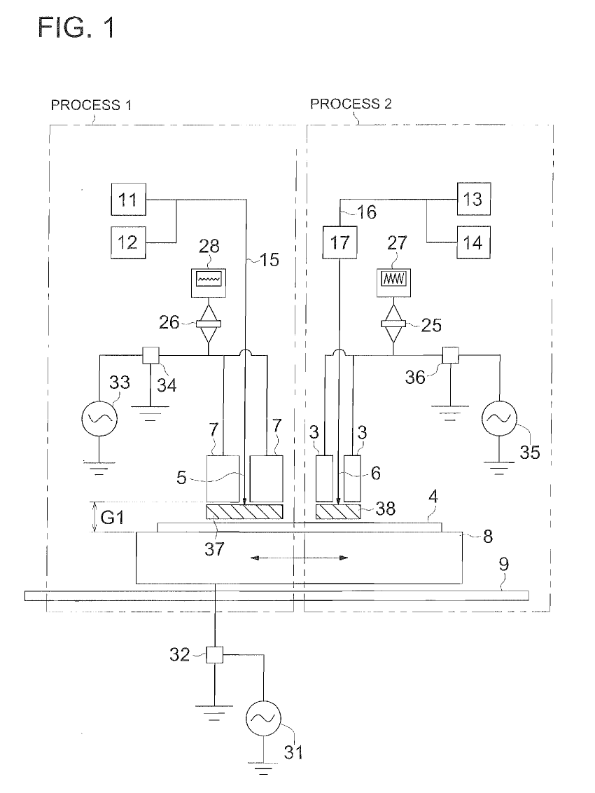

FIG. 1 is a schematic diagram representing an example of two-step type atmospheric pressure plasma apparatus. In the process 1 (area enclosed by a one-dot chain line in FIG. 1), counter electrodes (discharge space) are formed by a moving trestle electrode (first electrode) 8 and rectangular electrode (second electrode) 3, and high frequency electric field is applied between these electrodes. A gas 1 including a discharge gas 10, thin film forming gas 11 and auxiliary gas 12 is supplied through a gas supply pipe 15, and is led into the discharge space through a slit 5 formed on the rectangular electrode 3. The gas 1 is excited by discharge plasma, and the surface of the base material 4 (glass base material) placed on the moving trestle electrode 8 is exposed to the excited gas (37 in the drawing), whereby a thin film is formed on the surface of the base material.

The base material 4 together with the moving trestle electrode 8 gradually moves to the process 2 (area enclosed by a two-dot chain line).

In the process 2, counter electrodes (discharge space) are created by the moving trestle electrode (first electrode) 8 and rectangular electrode (second electrode) 7, and high frequency electric field is applied between the counter electrodes. A gas 2 including a discharge gas 13 and oxidizing gas 14 is supplied through a gas supply pipe 16, and is led into the discharge space through a slit 6 formed on the rectangular electrode 7. The gas 2 is excited by discharge plasma, and the surface of the base material 4 placed on the moving trestle electrode 8 is exposed to the excited gas 2 (38 in the drawing), whereby a thin film formed on the surface of the base material is oxidized. The moving trestle electrode 8 is provided with a traveling unit (not illustrated) capable of traveling back and forth on the support base 9 and stopping.

To adjust the temperature of the gas 2, a temperature regulating unit 17 is preferably arranged at some midpoint in of the supply pipe 16.

A thin film, having a desired thickness can be formed through back-and-forth traveling by the traveling frame between the thin film forming process as this process 1 and the oxidizing process as the process 2.

The first electrode (moving trestle electrode) 8 is connected with a first Dower source 31 and the second electrode 3 is connected with the second power source 33. A first filter 32 and a second filter 34 are connected between these electrodes and power sources. The first filter 32 discourages the passage of the current having the frequency from the first power source 31, and encourages the passage of the current having the frequency from the second power source 33. The second filter 34 behaves to the contrary; it discourages the passage of the current having the frequency from the second power source 33, and encourages the passage of the current having the frequency from the first power source 31. In this manner, filters having their own intrinsic functions are employed.

In the process 1 of the atmospheric pressure plasma apparatus of FIG. 1, the high frequency electric field is applied between the counter electrodes made up of the first electrode 8 and second electrode 3; namely, the first high frequency electric field having a frequency of ω₁, a field intensity of V₁, and a current of I₁ from the first power source 31 are applied to the first electrode 8, and the second high frequency electric field having a frequency of ω₂, a field intensity of V₂, and a current of I₂ from the second power source 33 are applied to the second electrode 3. The first power source 31 can apply higher intensity of the high frequency electric field higher than the second power source 33 (V₁>V₂), and the first frequency ω₁ of first power source 8 can be applied lower than the second frequency ω₂ of the second power source 33.

Similarly, in the process 2, the high frequency electric field is applied between the counter electrodes made up of the first electrode 8 and third electrode 7; namely, the first high frequency electric field having a frequency of ω₁, a field intensity of V₁ and a current of I₁ is applied to the first electrode 8 by the first power source 31; and, the third high frequency electric field having a frequency of ω₃, a field intensity of V₃ and a current of I₃ 35 is applied to the third electrode 7 by the third power source.

The first power source 31 can apply higher intensity of the high frequency electric field higher than the third power source 35(V₁>V₃), and the first frequency ω₁ of first power source 8 can be applied lower than the third frequency ω₃ of the second power source 33.

FIG. 1 also shows the measuring instrument used to measure the intensity (intensity of the electric field) of the aforementioned high frequency electric field and the intensity IV1 of the discharge start electric field. The reference numerals 25 and 26 indicate a high frequency voltage probe, and reference numerals 27 and 28 indicate an oscilloscope.

As described above, if two high frequency electric fields having different frequencies are superimposed on to the rectangular electrode 3 and moving trestle electrode 8 constituting the counter electrodes, a satisfactory plasma discharge can be formed, even when a less costly gas such as nitrogen gas is employed. Further, immediately thereafter, of a processing is applied in an oxidizing atmosphere, a thin film characterized by excellent properties can be produced.

Needless to say, atmospheric pressure plasma treatment can be provided by one high frequency power source, by selecting a discharger gas, auxiliary gas or thin film forming gas, without having to superimpose the high frequency electric field.

The surface of the glass base material can be activated by applying a high frequency electric field in the process 1 alone, and selecting a discharge gas or auxiliary gas, without the thin film forming gas being supplied.

The following describes the image forming apparatus wherein a glass member is used as a reading glass.

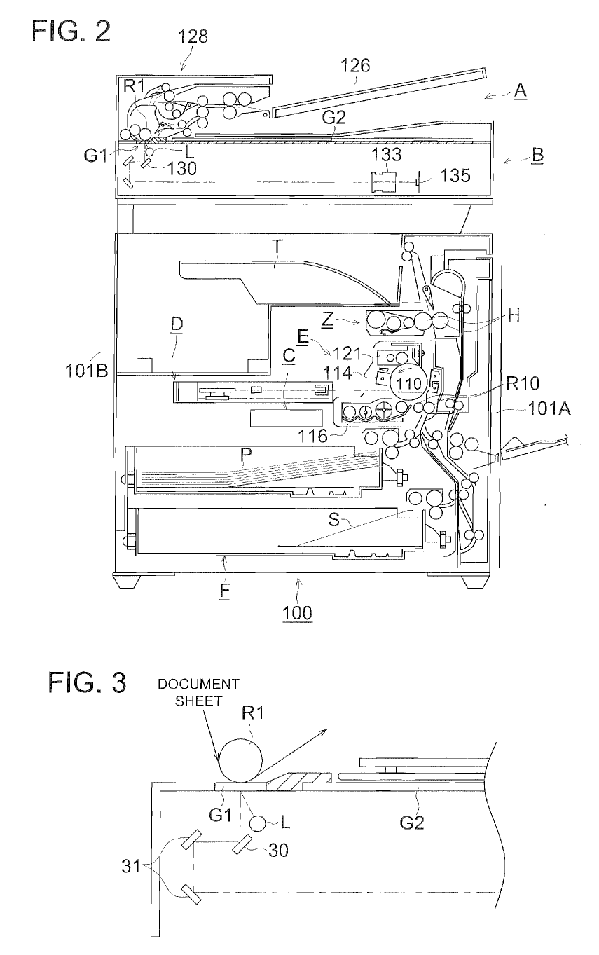

FIG. 2 is a schematic diagram representing the cross section of an example of the image forming apparatus utilizing the reading glass of the present invention.

In FIG. 2, in the image forming apparatus 100, a reverse side frame member (not shown) and frame members 101A and 101B on either side are formed so as to constitute the skeleton of the image forming apparatus 100. In the frame members 101A and 101B, there are provided an automatic document sheet conveyance means A; a reading section B for reading an image on document sheets conveyed by the automatic document sheet conveyance means A; an image control board C to process the read images of the document sheets; an image forming means E including an electrostatic latent image formation apparatus composed of a photoreceptor 110, an exposing device D and an electrically-charging electrode 114, a developing device 116, and cleaning device 121; and a sheet feeding means F to store a recording sheet P.

The automatic document feed apparatus A comprises, as main elements, a document platen 126, a roller group including a roller R1, and a document sheet conveyance processing section 128 including a switching unit (without reference numeral) for properly switching a document path.

In the document image reading section B, there are provided a reading glass G1 according to the present invention and a platen glass G2, and under theses glasses, the document image reading section B is structured with two mirror units 130 and 131 capable of moving back-and-forth while maintaining a constant optical path, a image forming lens 133 and a line-shaped CCD 135.

In the case of reading a document sheet placed on platen glass G2, a light exposing means L and mirror units 130 and 131 relatively move to the document sheet so that scanning reading can be conducted for the fixed document sheet.

On the other hand, in the case of reading document sheets placed on a document loading stand 26 of an automatic document sheet conveying means A, the first document sheet is conveyed by the document sheet conveyance processing section 128, and then, while the first document sheet is passing through between rollers R1 and a reading glass G1, a light exposing means L conducts exposure for the first document sheet, and the reflected light from the first document sheet enters into a fixed CCD 135 through fixed mirror units 130 and 131 and an image forming lens 133. After the first document sheet is read out with the shove way, the following document sheets are conveyed sequentially and the following document sheets are read out with the same way.

The image information read by the reading section B is processed by an image control means C, is coded, and then stored in a memory provided in the image control means C.

A semiconductor laser in an image writing means D is driven in accordance with image data, and scanning exposure is performed on a photoreceptor 110 with the laser beam by rotation of a rotating polygon mirror.

In an image formation, while the photoreceptor 110 is rotating in the direction of an arrow (counterclockwise direction), the photoreceptor 110 is given with a predetermined surface potential by a corona discharging action of an electrically-charging electrode 114, and then is exposed by an image writing means D, whereby an electrostatic latent image is formed on the photoreceptor 110.

A recording sheet P is conveyed by a resist roller R10 rotating in synchronization with a toner image formation on the photoreceptor 110.

In a transferring region, a toner image on the photoreceptor 110 is electrostatically transferred on the recording sheet P by a transferring electrode, and subsequently, the recording sheet P is subjected to charge elimination by a separating electrode so as to be separated from the photoreceptor 110.

A fixing means H has a heating roller, a pressure roller, and a cleaning means Z, and by being pressed and heated by the fixing means, and the toner image is melted and fixed on the recording sheet P. Thereafter, the recording sheet P is delivered onto a delivery tray T through a delivery roller.

FIG. 3 is an expanded sectional view in the vicinity of a reading glass G1 according to the present invention. While a document sheet is conveyed and brought in pressure contact with the reading glass G1 by a roller R1, the document sheet is exposed with light by an exposure means L. The reflected light from the document sheet is guided by a mirror unit 130, 131 and enters into a CCD through an un-illustrated image forming lens.

Here, the reading glass according to the present invention makes it as a requirement to be applied to a reading glass of a conveyed document sheet reading section at least in an image reading section of an image forming apparatus or a scanner. The reason is that it turns out that since contact friction with a document sheet is conducted repeatedly on a document passing surface (a surface coming in contact with a document sheet) of the conveyed document sheet reading section, when the low friction antifouling layer of the present invention is applied on the document passing surface, dust such as paper powder can be prevented from occurring on the sheet reading section. Further, since the sheet reading section can be provided with low adhesive property, it is possible to prevent adhesive matter from adhering on there and to reduce stain, and it is possible to maintain the low friction antifouling property for a long term.

Further, it is desirable that the reading glass of the present invention is also applied to the platen glass G2.

Furthermore, in the present invention, it is desirable to form a transparent conductive film on a surface of the reading glass opposite to the contact surface (sheet passing surface) with the document sheets. When the transparent conductive film is formed, triboelectrification can be prevented and adhesion of paper powder by static electricity can be also prevented.

### Example

Each reading glass was produced as follows.

As the glass base material, a commercially marketed 3 mm thickness and chemically strengthened glass was used. Here, the iron concentration of each glass surface was analyzed.

Further, the surface of a glass base material later was subjected to an activating treatment by a corona discharge treatment or an atmospheric pressure plasma as mentioned later. The concentration of iron in each sample and the combination of surface activations are shown in Table 1.

The measurement of surface elementary composition was conducted by a XPS surface analyzer (ESCALAB-200R manufactured by VG scientific company). The measurement was conducted on the condition that an angle (takeoff angle) between a sample and a detecting element was 30°, a spot diameter was 1 mm, and the detection depth was several nm on the uppermost surface.

The following fluorine atom containing film was provided to both sides of each glass base material by a dip coating method.

As a silane coupling agent to form the fluorine atom containing film, OPTOOL DSX manufactured by Daikin Industries, LTD. was diluted with HFE-7100 manufactured by Sumitomo 3M company to 0.1%. The glass base material was dipped in this solution, and superfluous droplets were removed from the glass base material, and then the glass base material was dried.

As a method of distinguishing the top surface and bottom surface of a chemically strengthened glass, a method of measuring a surface tin (Sn) concentration by the above-mentioned XPS surface analyzer (usually, the tin concentration of the top surface is 0.1 to 1.0 atomic percent and the tin concentration of the bottom surface is 3.0 atomic percent or more) a method of judging a plane looked cloudy as a bottom surface at the time of exposing ultraviolet ray to a glass plane in a dark place, can be used.

As the surface activating treatment for a glass base material, a corona discharge treatment was conducted for 30 seconds with a gap of about 3 mm by AP-400 manufactured by Kasuga Electric Works, Ltd.

In Example 7, the same glass base material as Example 1 was used, and a SnO2 film was formed with a thickness of 10 nm on the bottom surface of the glass base material as a transparent conductive film by the atmospheric pressure plasma process mentioned later, thereafter, a low friction antifouling layer was formed on both sides of the glass base material with the dip method as same as Example 1.

As the surface activating treatment for a glass base material, the treatment by the atmospheric pressure plasma process will be explained below.

### <<Activating Treatment for the Surface of a Glass Base Material by an Atmospheric Pressure Plasma>>

As the activating treatment for the surface of a glass base material, a treatment by only Process 1 was conducted under the following conditions with the atmospheric pressure plasma equipment shown in FIG. 1.

### (Power Source Conditions)

Power Sources to be Superposed

High frequency power source 1: High frequency power source by Pearl Industry

Electric field frequency ω₂: 13.56 MHz

Output density: 11 W/cm²

High frequency power source 2: Impulse high frequency power source manufactured by Heiden Research Laboratory

Electric field frequency ω₁: 100 kHz

Output density: 16 W/cm²

### (Electrode Conditions)

The moving trestle electrode as the first electrode and the rectangular electrode as the second electrode were manufactured by a process of spraying ceramic as a dielectric on a rectangular hollow titanium pipe.

Thickness of dielectric: 1 mm

Width of electrode: 40 mm

Applied electrode temperature: 90° C.

Gap between electrodes (G1 in FIG. 1): 4.5 mm

### (Gas Conditions)

Discharge gas N₂: 20 slm

Auxiliary gas O₂: 1 slm

### (Moving Trestle Electrode)

Moving trestle electrode temperature: 200° C.

The moving trestle electrode 8 in Process 1 was connected with the high frequency power source 1 (power source 31 in FIG. 1), and the rectangular electrode 3 was connected the high frequency power source 2 (power source 33 in FIG. 1). Back-and-forth movement was carried out about respective times at a moving speed of 100 mm/second.

### <<Formation of SnO₂ Film by Atmospheric Pressure Plasma>>

A transparent conductive film was formed by the two step film formation (Process 1 and Process 2) by the use of the atmospheric pressure plasma apparatus shown in FIG. 1.

The rectangular electrode 3 in Process 1 and the rectangular electrode 7 in Process 2 were connected in parallel and connected to the high voltage side of the power source, and the moving trestle electrode was connected to the low voltage side of the power source. In FIG. 1, the high frequency power source 31 alone was used as a power source. Immediately after a thin film was formed under the reduction conditions in the following Process 1, an oxidation treatment in Process 2 was carried out. Process 1 and Process 2 were repeated, whereby a SnO₂ film having a thickness of 10 nm was formed.

### [Process 1: Film Forming Process]

Power source (High frequency power source manufactured by Pearl Industry)
ω: 27 MHz, Output density: 4.7 W/cm²
Gap between electrodes: 1.0 mm

(Gas Condition 1)
Argon gas for vaporizing tetramethyltin: 0.2 L/min, 15° C.
Discharge gas: Ar 90 L/min
Reductive gas: H₂, 0.8 L/min

### [Process 2: Oxidation Process]

Power source (common with Process 1)
ω: 27 MHz, Output density: 13 W/cm²
Gap between electrodes: 1.5 mm

(Gas Condition 2)
Discharge gas: Ar 70 L/min
Oxidized gas: O₂, 0.3 L/min

### <<Evaluation>>

The following evaluations were performed for each obtained reading glass.

### <Compulsive Abrasion Test>

By the use of an abrasion test machine HEIDON-14DR (manufactured by HEIDON Company), 5000 time repetition abrasion tests were carried out for the surface of each reading glass with the surface of a copy paper of a ream weight of 55 kg in 1 kg/cm² and 20 mm/sec.

### <Measurement of Contact Angle>

The contact angle of the surface of each reading glass before and after the above-mentioned compulsive abrasion test was measured by the G-1 contact angle measuring instrument manufactured by ERMA Company.

### <<Actual Machine Test>>

### <Magic Ink Wiping Test>

By the use of commercially available oil based black magic ink (M500-T1), the magic ink wiping test was conducted a portion of a reading glass where paper passed over under a pressure of a roller.

The evaluation criterion for the magic ink wiping is as follows.

A: Non writable, well repellent

B: Non writable, repellent

C: Writable, but able to be wiped

D: Unable to be wiped

### <Dust Adhesion, Black Streak>

By the use of Bizhab 350 manufactured by Konica Minolta Business Technologies Inc, actual copy evaluation was conducted by the application of each reading glass at the reading glass G1 of the reading section B of a copying machine shown in FIG. 3.

By the use of a commercially available A4 size paper of a ream weight of 55 kg as document sheets, and 200,000-sheet automatic continuous sheet passing was carried out.

After the sheet passing, an evaluation document sheet prepared in such a way that a cellophane tape (made by Nichiban Co., Ltd.) according to JIS specification was cut into 20 mm long by a commercially available tape cutter and the 20 mm long cellophane tapes were passed with an arrangement of 14 lines in longitudinal direction and 7 lines in transverse direction on a commercially available A4 size paper of a ream weight of 55 Kg, was passed through four times on the above evaluation machine. The number of black streak formed the image printed an the 4th sheet was evaluated as failure. Further, after the sheet passing, the top plate was opened, and the number of foreign matters deposited on the reading glass was evaluated as the number of dust adhesion.

### <Image Quality>

By the use of the above samples, the image quality was visually evaluated with the following ranks.

AA: No streak noise and no dot-form failure

A: Almost no streak noise and no dot-form failure

B: Streak noise and dot-form failure exist

C: Many streak noise and dot-form failure exist

Each evaluation result is shown in Table 1.

TABLE 1

| | | | | | Water contact angle | | | Actual machine test, image | | | |
|---|---|---|---|---|---|---|---|---|---|---|---|
| | | | | | after compulsive | | | evaluation after the passing | | | |
| | | Surface | Surface iron | Surface tin | abrasion | | | of 200,00 sheets | | | |
| | Processed | treatment | content | content | | | Dura- | Magic | Number of | Black | Image |
| | surface | method | (atm %) | (atm %) | Before | After | bility | ink | dust adhesion | streak | quality |
| Inv. 1 | bottom | *1 | 0.1 or less | 3 | 110 | 95 | B | B | 17 | 6 | B |
| Inv. 2 | bottom | *1 | 0.1 or less | 1.5 | 108 | 104 | A | A | 5 | 1 | A |
| Inv. 3 | top | *1 | 0.1 or less | 0.3 | 112 | 108 | AA | AA | 2 | 0 | AA |
| Inv. 4 | top | *1 + (back) | 0.1 or less | 0.3 | 112 | 108 | AA | AA | 0 | 0 | AA |
| | | transparent | | | | | | | | | |
| | | conductive film | | | | | | | | | |
| Inv. 5 | top | Corona discharging | 0.2 or less | 1.3 | 111 | 107 | AA | AA | 1 | 1 | AA |
| | | treatment + | | | | | | | | | |
| | | (back) transparent | | | | | | | | | |
| | | conductive film | | | | | | | | | |
| Comp. 1 | bottom | No treatment | 0.3 | 3 | 95 | 75 | C | C | 66 | 34 | C |
| Comp. 2 | bottom | *1 | 0.3 | 3 | 98 | 60 | C | C | 32 | 27 | C |
| Comp. 3 | bottom | *1 | 0.5 | 1.5 | 110 | 86 | C | C | 37 | 36 | C |
| Comp. 4 | top | *1 | 0.8 | 0.3 | 110 | 75 | C | C | 47 | 41 | C |
| Comp. 5 | top | *1 | 1.2 | 0.3 | 110 | 55 | C | C | 87 | 49 | C |

Inv.: Inventive example,
Comp.: Comparative example,
*1: Atmospheric plasma

In comparison with comparative samples, in each of the reading glasses of the present invention, the number of dust adhesion and the number of black streaks are very few respectively, and its result of the magic ink wiping test shows an excellent result. Therefore, it turns out that a low friction antifouling film excellent in durability is formed. Further, it is noted that the reading glass in which the SnO₂ transparent conductive film is formed on its back surface exhibits further excellent performance.

1-7. (canceled)

8. A transparent member, comprising:
a base material in which an elemental composition of a surface of the base material contains 0.1 atomic percent or less iron atoms and 3 atomic percent or less tin atoms, and
a low friction antifouling film formed on the surface of the base material and containing fluorine atoms.

9. The transparent member described in claim 8, wherein the low friction antifouling film is made of a fluoro alkyl group containing silane compound.

10. The transparent member described in claim 8, wherein the surface of the base material is subjected to an activating treatment before the low friction antifouling film is formed on the surface.

11. The transparent member described in claim 10, wherein the activating treatment is at least one selected from a corona treatment, a plasma treatment, an atmospheric pressure plasma treatment and a flame treatment.

12. The transparent member described in claim 8, wherein the base material is a melted float glass and the low friction antifouling film is formed on a top surface of the melted float glass.

13. A reading glass having a sheet passing surface and for reading a document sheet passing the sheet passing surface, comprising:
a glass member in which an elemental composition of a surface of the glass member contains 0.1 atomic percent or less iron atoms and 3 atomic percent or less tin atoms; and
a low friction antifouling film formed on the sheet passing surface of the glass member and containing fluorine atoms.

14. The reading glass described in claim 13, further comprising:
an antistatic film formed on a surface opposite to the sheet passing surface on which the low friction antifouling film is formed.
